(19) United States
(12) Patent Application Publication
(10) Pub. No.: US 2011/0133961 A1
(43) Pub. Date: Jun. 9, 2011

(54) Automobile Locating System

(76) Inventor: Eric J. Markovics, Inglewood, CA (US)

(21) Appl. No.: 12/851,770

(22) Filed: Aug. 6, 2010

Related U.S. Application Data
(60) Provisional application No. 61/283,804, filed on Dec. 9, 2009.

(51) Int. Cl. G08G 1/123

(52) U.S. Cl. 340/988

(57) ABSTRACT

An automobile tracking system for use in locating an automobile whose location is generally but not specifically known includes a housing removably mountable in an automobile. A transmitter is positioned in an interior of a housing and electrically connected to a power source. A transmitter processor is positioned in the housing in data communication with the transmitter. Programming is utilized with the transmitter processor to associate an identifier with signals transmitted by the processor. The system includes a casing having a display and receiver coupled thereto. A receiver and display are positioned in the casing and connected to a power supply and a receiver processor. Programming is utilized by the receiver processor to indicate on the display (1) a location of the transmitter based on data received by the receiver from the transmitter, and (2) a respective identifier associated with the transmitter.

### CROSS-REFERENCE TO RELATED APPLICATIONS

The present invention claims the benefit of U.S. Provisional Patent Application, Ser. No. 61/283,804, filed on Dec. 9, 2009 titled Automobile Locator.

### BACKGROUND OF THE INVENTION

This invention relates generally to electronic locating devices and, more particularly, to an automobile tracking system for quickly finding an automobile when lost in a parking lot, garage, or other public area.

Americans utilize the automobile more than any other people, anywhere, practically living on wheels. Shopping centers, banks, restaurants, and even churches have been arranged to serve people in automobiles. Because so much vacation and other pleasure touring is done in automobiles, motels and parks have accommodations for large number of passenger cars, vehicles towing trailers, and light trucks (often called recreational vehicles, or RV's) that contain kitchen facilities and beds. To accommodate the ever-growing population of automotive vehicles, parking lots and garages dot the urban landscape and new ones are constantly being built. Even with the many parking lots available, drivers frequently encounter two problems associated with parking lots, finding an open parking space and, upon returning, finding the car.

While it can be frustrating circling around a parking lot in hopes of locating a prime parking space, this challenge is minimal compare to the quandary experienced when on cannot relocate where they did park. Rows upon rows and levels upon levels of parking spaces at shopping malls, industrial complexes, and stadiums can result in a veritable sea of similar looking automobiles, leading to much confusion on the part of the motorist. While losing the car in such a manner can certainly be embarrassing, it is more annoying and frustrating, especially when returning from shopping with arms loaded with heavy bags, or in the pouring rain or under the blazing sun. Moreover, searching for one's parked car after dark can be quite dangerous, as hapless wondering can leave one susceptible to attack.

Various devices have been proposed in the prior art for locating various objects. Although assumably effective for their intended uses, the existing devices do not provide a radio frequency identification device that is integrated with a traditional automobile keyless entry device and uses radio frequency technology and a display to guide a vehicle owner to a lost vehicle in a public area such as a shopping center parking lot.

Therefore, it would be desirable to have an automobile tracking system that remedies all of the disadvantages and limitations of the existing devices or proposals.

### SUMMARY OF THE INVENTION

An automobile tracking system for use in locating an automobile whose location is generally but not specifically known, according to the present invention, includes a housing removably mountable in an automobile. A transmitter is positioned in an interior of a housing and electrically connected to a power source. A transmitter processor is positioned in the housing in data communication with the transmitter. Programming is utilized with the transmitter processor to associate an identifier with signals transmitted by the processor. The system includes a casing having a display and receiver coupled thereto. A receiver and display are positioned in the casing and connected to a power supply and a receiver processor. Programming is utilized by the receiver processor to indicate on the display (1) a location of the transmitter based on data received by the receiver from the transmitter, and (2) a respective identifier associated with the transmitter.

Therefore, a general object of this invention is to provide an automobile tracking system that enables a user to locate an automobile that is essentially lost in a parking lot.

Another object of this invention is to provide an automobile tracking system, as aforesaid, that integrates the security system with a vehicle's keyless entry system.

Still another object of this invention is to provide an automobile tracking system, as aforesaid, in which a user may use a handheld device to cause a transmitter previously mounted in a vehicle to begin sending location signals.

Yet another object of this invention is to provide an automobile tracking system, as aforesaid, in which the handheld device includes a display having arrows that illuminate to direct the user to the vehicle being searched for.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an automobile tracking system according to a preferred embodiment of the present invention;

FIG. 2 is a perspective view on an enlarged scale of a locating unit as in FIG. 1; and

FIG. 3 is a block diagram of the electronic components of the tracking system as in FIG. 1.

### DESCRIPTION OF THE PREFERRED EMBODIMENT

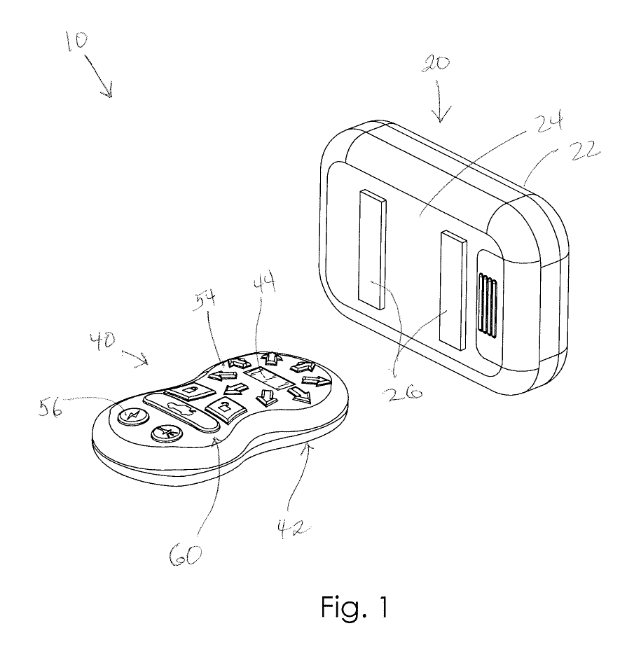

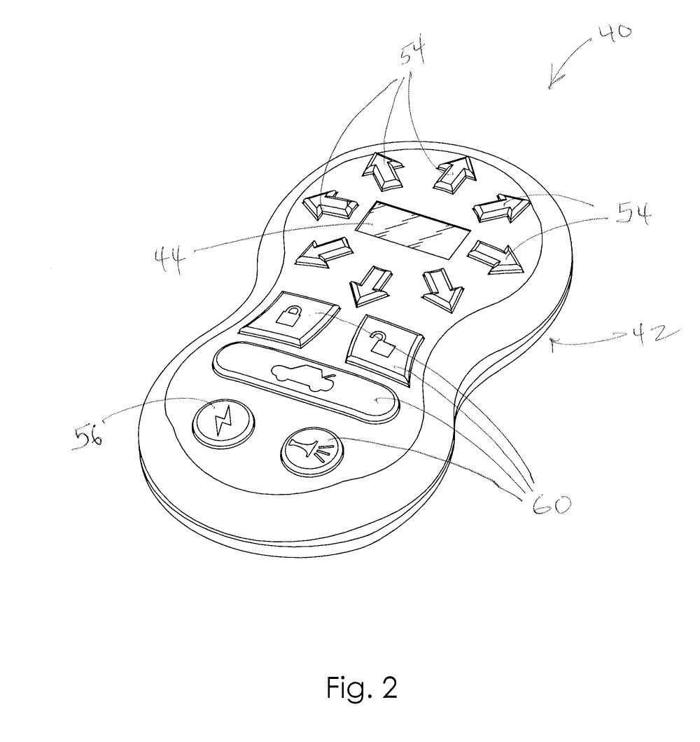

An automobile tracking system for use in locating an automobile whose location is generally but not specifically known will now be described in detail with reference to FIGS. 1 to 3 of the accompanying drawings. The automobile tracking system 10 according to one embodiment of the present invention includes a transmission unit 20 and a locating unit 40 that work together to lead a user, such as an automobile owner, to a vehicle that is essentially lost in the crowd of other vehicles at a public parking location, such as a shopping mall parking lot.

The transmission unit 20 includes a housing 21 having at least front 22 and back 24 walls and defines an interior space. Preferably, the back wall 24 includes means for being mounted to an interior structure in a vehicle, such a dashboard, console, door panel, or the like. The mounting means may be an adhesive backing 26, a fastener, or the like. It is understood, however, that the transmission unit 20 is not required to be mounted inside the car, but rather may be positioned another way, such as hanging from the rearview mirror or the like.

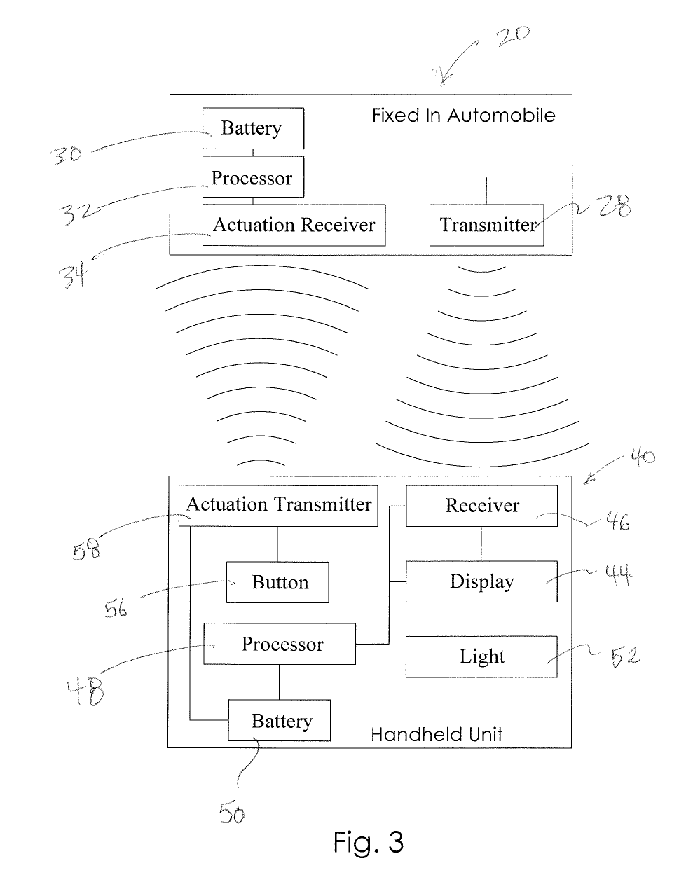

As best shown in FIG. 3, the transmission unit 20 includes a transmitter 28 positioned in the housing interior space. A first power source 30, such as a battery, is also positioned with the interior space and is electrically connected to the transmitter 28. A processor 32, also referred to as a transmitter processor for clarity, is also positioned in the interior space of the housing 21 and is in data communication with the transmitter 28. Programming is utilized by the transmitter processor 32 to associate an identifier with the signal transmitted by the transmitter 28 when actuated to do so by the transmitter processor 32. It is understood that the programming may be directly stored by the transmitter processor 32, such as through circuitry, or there may alternately be provided a memory component connected to the transmitter processor 32 on which the programming is stored. In operation, the programming described above will actuate the transmitter to send signal data when actuated to do so, as will be further described below. The transmitter 28 may be a radio frequency transmitter, a GPS device, a combination of radio frequency identification (RFID) components, or the like, as will be described further later.

The transmitter processor 32 also utilizes programming to associate a unique identifier with signals transmitted by the transmitter processor 32 through the transmitter 28. In other words, the transmitter processor 32 includes a unique code identifying itself within the alert signals being transmitted. This enables a user to verify that signals being received are being sent from the transmission device in his car and not that of another person.

The locator unit 40 is a handheld device that a user may carry with him while shopping after parking his vehicle and then use to locate the vehicle at a later time. The locator unit 40 includes a casing 42 having walls that define an interior space. A display 44 is operatively coupled to the casing 42, such as being situated on a top surface for optimal viewing by a user. A receiver 46 may be coupled to or positioned inside the casing 42. The locator unit 40 also includes a processor 48, also referred to as a receiver processor 48 so as to be distinguished from the transmitter processor 32 described above. A second power source 50, such as a battery, is electrically connected to the display 44, receiver 46, and receiver processor 48 and may be positioned inside the casing 42.

The receiver processor 48 operates by executing programming to indicate on the display 44 a location of the user's vehicle based on data received by the receiver 46 from the transmitter 28 of the transmission unit 20. Again, it is understood that the programming may be stored on a memory device or be included with the receiver processor 48 itself. More particularly, the transmitter 28 may send radio frequency signals when actuated to do so. The receiver 46, in cooperation with the receiver processor 48 may receive and interpret the strength and direction of the transmitted signals to determine a location from which the signals are coming and an estimated distance. Accordingly, the display 44 may be actuated to display this data. Alternatively, the transmitter 28 may send global position satellite data which, when interpreted by the receiver processor 48, may enable the display 44 to indicate an exact location of the transmission unit 20.

Programming of the receiver processor 48 may also be utilized to indicate on the display 44 a respective identifier associated with the transmitter 28 based on data received by the receiver 46 from the transmitter 28. Receipt and display of the transmitter identifier, of course, enables a user to verify that it is receiving location signals from the correct automobile.

Further, the locating unit 40 may include a light to assist a user in viewing the display 44 in dim lighting conditions, such as dusk or night. The light 52 may be positioned beneath or adjacent to the display 44 so as to form a “backlight” effect. It is understood that the light 52 may be electrically connected to the second power source 50 and to the display 44 and have means to selectively activate or deactivate the light 52.

In addition, the locating unit 40 may include another plurality of lights 54 positioned on the casing 42 or integrated with the display 44 that are electrically connected to the receiver processor 48. Preferably, these additional lights 54 may be a set of 8 directional arrows that operate to indicate the direction from which received signals are being received. The directional lights 54 are in electrical communication with the receiver processor 48 such that respective arrow lights may be illuminated based on data received by the receiver 46 from the transmitter 28. Again, it is understood that the receiver processor 48, utilizing programming, is capable of interpreting signals, including signal strength and directional attributes, and then to actuate the display 44 and directional lights 54 accordingly. The locating unit 40 may include an antenna (not shown) in communication with the receiver 46 for enhancing reception of transmitted signals.

Further, the locator unit 40 may include means for actuating the transmission unit 20 to begin sending locator signals, such as radio signals. More particularly, the locator unit 40 may include an input button 56 positioned on the casing 42. The input button 56 may be electrically connected to an actuation transmitter 28 positioned in the casing 42. When the input button 56 is pressed, the actuation transmitter 28 sends a signal. Further, the transmission unit 20 may include an actuation receiver 34 positioned in the housing 21 and electrically connected to the transmitter processor 32. When the actuation receiver 34 receives an expected signal from the actuation transmitter 28, the transmitter processor 32 actuates the transmitter 28 to begin sending location signals. Therefore, the transmission unit 20 is only activated (and uses power) only when specifically activated by a user.

Preferably, the locator unit 40 is integrated with a keyless entry device associated with the vehicle to be located. Accordingly, the casing 42 may include additional input buttons 60, such as door lock/unlock, open trunk, and a panic button. The receiver processor 48 may utilize additional programming to operate the actuator transmitter to send respective signals to control respective automobile functions, as is known in the art.

In another embodiment of the present invention, the transmitter 28 and receiver 46 may utilize RFID technology. More particularly, the receiver 46 may be a passive RFID reader and the transmitter 28 may be an RFID tag. The receiver 46 is actually a transceiver—having a transmitter for sending query signals and a receiver for receiving reply signals from the tag. Similarly, the transmitter 28 includes a receiver for receiving query signals from the RFID reader and a transmitter for sending reply signals. In operation, the RFID reader sends signals “looking” for the tag and then receives a reply signal from the tag. As described previously, programming may be utilized to interpret the reply signals and actuate the display 44 to indicate distance or direction.

It is understood that while certain forms of this invention have been illustrated and described, it is not limited thereto except insofar as such limitations are included in the following claims and allowable functional equivalents thereof.

What is claimed is:

1. An automobile locating system for use in locating an automobile whose location is generally but not specifically known, said locating system, comprising:
a housing having front and back walls, said back wall including means for removably mounting said housing to an interior of an automobile, said housing defining an interior area;
a transmitter positioned in said housing interior area;
a first power source situated in said housing interior area and being in electrical communication with said transmitter;
a transmitter processor positioned in said housing interior area and in data communication with said transmitter;
programming utilized by said transmitter processor to associate an identifier with signals transmitted by said transmitter processor;
a casing;
a display operatively coupled to said casing;
a receiver operatively coupled to said casing;
a power source in electrical communication with said display and said receiver;
a receiver processor in data communication with said display and said receiver;
programming utilized by said receiver processor to indicate on said display a location of said transmitter based on data received by said receiver from said transmitter; and
programming utilized by said receiver processor to indicate a respective identifier on said display that is associated with said transmitter based on data received by said receiver from said transmitter.

2. The tracking system as in claim 1, wherein said transmitter is a radio transmitter.

3. The tracking system as in claim 1, wherein said transmitter is a GPS transmitter.

4. The tracking system as in claim 1, further comprising a light in electrical communication with said display so as to selectively backlight said display.

5. The tracking system as in claim 1, further comprising:
an actuator transmitter positioned in said casing;
an input positioned on said casing and electrically connected to said actuator transmitter for selectively causing said actuator transmitter to send a start signal;
an actuator receiver positioned in said housing and electrically connected to said transmitter processor;
programming in said transmitter processor to cause said transmitter processor to being transmitting location data when said actuation receiver receives said start signal.

6. The tracking system as in claim 1, further comprising:
a plurality of lights positioned on said casing and electrically connected to said receiver processor; and
programming in said receiver processor for illuminating respective lights to indicate a location of said transmitter based on data received by said receiver from said transmitter.

7. The tracking system as in claim 6, wherein said plurality of lights are configured respectively in the form of directional arrows.

8. An automobile locating system for use in locating an automobile whose location is generally but not specifically known, said locating system, comprising:
a transmission unit, including:
a housing having front and back walls, said back wall including means for removably mounting said housing to an interior of an automobile, said housing defining an interior area;
a transmitter positioned in said housing interior area;
a first power source situated in said housing interior area and being in electrical communication with said transmitter;
a transmitter processor positioned in said housing interior area and in data communication with said transmitter;
programming utilized by said transmitter processor to associate an identifier with signals transmitted by said transmitter processor;
a locating unit, including:
a casing;
a display operatively coupled to said casing;
a receiver operatively coupled to said casing;
a power source in electrical communication with said display and said receiver;
a receiver processor in data communication with said display and said receiver;
programming utilized by said receiver processor to indicate on said display a location of said transmitter based on data received by said receiver from said transmitter;
programming utilized by said receiver processor to indicate on said display a respective identifier that is associated with said transmitter based on data received by said receiver from said transmitter;
a plurality of lights positioned on said casing and electrically connected to said receiver processor; and
programming in said receiver processor for illuminating respective lights to indicate a location of said transmitter based on data received by said receiver from said transmitter.

9. The tracking system as in claim 8, wherein said plurality of lights are configured respectively in the form of directional arrows.

10. The tracking system as in claim 9, further comprising a light in electrical communication with said display so as to selectively backlight said display.

11. The tracking system as in claim 8, further comprising:
an actuator transmitter positioned in said casing;
an input positioned on said casing and electrically connected to said actuator transmitter for selectively causing said actuator transmitter to send a start signal;
an actuator receiver positioned in said housing and electrically connected to said transmitter processor;
programming in said transmitter processor to cause said transmitter processor to being transmitting location data when said actuation receiver receives said start signal.

12. The tracking system as in claim 8, wherein:
said receiver is a passive RFID reader; and
said transmitter is a RFID tag.
